(19) United States
(12) Patent Application Publication
(10) Pub. No.: US 2022/0144409 A1
(43) Pub. Date: May 12, 2022

(54) Changeable Shape and Directional Foil

(71) Applicant: Alfred DeCozen Baldwin, Ormond beach, FL (US)

(72) Inventor: Alfred DeCozen Baldwin, Ormond beach, FL (US)

(21) Appl. No.: 17/514,504

(22) Filed: Oct. 29, 2021

Related U.S. Application Data
(60) Provisional application No. 63/198,759, filed on Nov. 11, 2020.

(51) Int. Cl. B64C 3/54; B64C 3/18; B64C 9/00; B64C 3/28

(52) U.S. Cl. CPC B64C 3/54; B64C 3/187; B64C 2009/005; B64C 3/28; B64C 9/00

(57) ABSTRACT

This invention discloses a new foil design for generating and changing lift in a fluid dynamic environment. The vessel/aircraft can change foil's lift coefficient by using independently rotatable and locking tubes with at least one flat area attached to axles which enables modification of the surface conformation of the foil. The foil is provided with means to control a pitch, a roll and a yaw motion and to control the position and stability of the aircraft. In one embodiment the foil is capable of maintaining lift upon inversion, or flipping of a vessel. In another embodiment the invention provides a novel device and methodology for modifying foil surface configurations for in-motion fluid dynamic efficiency.

### RELATED U.S PROFESSIONAL APPLICATION DATA

No. 63/198/759 Filed on Nov. 11, 2020

### CROSS-REFERENCE TO RELATED APPLICATIONS

Not applicable.

### STATEMENT REGARDING FEDERALLY SPONSORED RESEARCH/DEVELOPMENT

Not applicable.

### REFERENCE TO SEQUENCE LISTING, A TABLE, OR COMPUTER PROGRAM LISTING COMPACT DISC APPENDIX

Not applicable.

Current U.S. Class: 1/1
Current CPC Class: B64C 39/10 (2013 Jan. 1); B64C 3/52 (2013 Jan. 1);
B64C 9/10 (2013 Jan. 1); G05D 1/0816 (2013 Jan. 1); Y02T 50/10 (2013
Jan. 1); B64C 2039/105 (2013 Jan. 1)
Current International Class: B64C 3/52 (2006 Jan. 1); B64C 9/10 (2006
Jan. 1); B64C 39/10 (2006 Jan. 1); G05D 1/08 (2006 Jan. 1)

U.S. Patent Documents

| | | |
|---|---|---|
| 5,082,207 | January 1992 | Tulinius |
| 5,681,014 | October 1997 | Palmer |
| 10/279,891 | May 2019 | Krebs |
| 2008/0149779 | June 2008 | Phillips |
| 2009/0026321 | January 2009 | Sarhetal. |
| 2016/0001874 | January 2016 | Pittetal. |
| 2019/0202543 | July 2019 | Gatto |

Foreign Patent Documents

| | | |
|---|---|---|
| 7,699,270 | Apr. 20, 2010 | Lonsinger |
| 2644361 | October 2013 | EP |
| 20013/061351 | May 2013 | WO |

### FIELD OF THE INVENTION

This invention relates generally to a changeable shape foil/wing by using tubes with differently shaped sides that rotate and lock into position.

### BACKGROUND OF THE INVENTION

Airfoils and hydrofoils of various shapes and configurations are used to generate fluid dynamic lift. In this disclosure, wing and foil are used interchangeably, and refer to a structure designed for movement through a fluid dynamic environment, including air and water. The terms vessel and craft are also used interchangeably, and refer to the body capable of movement that wings or foils are attached to. This invention is useful in various fluid dynamic environments, and this disclosure contemplates, but is not limited to aviation and nautical applications.

The leading edge of the foil is shaped to produce a flow of fluid at a higher velocity over the top of the foil as compared to the wind speed on the bottom of the foil. The Bernoulli Effect, the pressure sensed at the foil surfaces is reduced, but because the fluid velocity at the top foil surface is greater than that at the lower, a lower pressure will be sensed at the top. This differential pressure creates lift used to produce flight. Fixed-wing aircraft use forward motion of the aircraft to produce the fluid flow required to generate lift

Having the option of changing the lift/drag coefficient in flight offers many advantages. In order to control and optimize the forces acting on a foil, such as lift and drag, some foil structures employ designs whereby a primary surface is equipped with a control surface, such as flaps (for lift) and ailerons (for roll axis control), which affect both lift and drag. When activated, the control surface position relative to the foil changes, providing altered fluid dynamic flow over the foil.

Typically, control surfaces are rigid, and move horizontally or vertically relative to the foil. Inventions have been disclosed that provide variable contour control surfaces. One challenge with these variable contour control surfaces is that they distort the surface of the foil, changing flow and resulting in inefficiencies such as increased drag or decreased lift. It would be advantageous for a foil to accommodate a moveable control surface which minimized or eliminated surface contour distortion. In some fluid dynamic applications it is necessary to change direction abruptly or inverted foil configuration to accommodate directional changes and vessel body positional changes, while maintaining optimized fluid dynamic efficiencies.

### BRIEF SUMMARY OF THE INVENTION

The invention disclosed is a device and method of using the device for generating lift in a fluid environment incorporating a foil design capable of instantly shifting the foil surface conformation. In another configuration the foil maintains lift after the vessel body inverts. The device incorporates the shape of a foil design to create lift, and comprising of a leading edge, trailing edge, ribs and various shape turnable tubes attached to axles. The device's tubes are housed within the foil, and are substantially conical, include one or more flattened areas and include one or more differently foiled shaped top surface area's.

Releasable rotational tubes are positioned such that a flat portion of each tube component moves into coplanar alignment with the bottom surface of the foil when it stops rotating, defining a relatively flat bottom surface. At the same time a rounded portion moves into position with the curved part of the foil to maintain the angle and curvature of the top surface. Flexible spacers help fill in the gaps between the tubes to help create a smooth surface. One skilled in the art would recognize that other geometric configurations could be used and achieve the desired function.

In one embodiment tubes attached to axles with one flat sided located within the foil rotate while the entire vessel is inverted or flipped, maintaining fluid dynamic efficiencies in the new orientation. In another embodiment, two flat sided tubes attached to axles with two different top shapes independently rotate to change fluid dynamic efficiencies of the vessel. These different embodiments enable use of the device in a variety of foil configurations and environments.

### REFERENCE CHARACTERS USED IN THE DRAWINGS

1—Vessel body
5—Symmetric leading edge
10—Asymmetric leading edge
15—Symmetric trailing edge
20—Asymmetric trailing edge
25—Asymmetric foil tip
30—Asymmetric rib
35—Axle
40—Tube
45—Tube strut
50—Engine
55—Spacer
60—Spacer spring
65—Flexible joints
70—Flap
75—Aileron

### BRIEF DESCRIPTION OF THE THE DRAWINGS

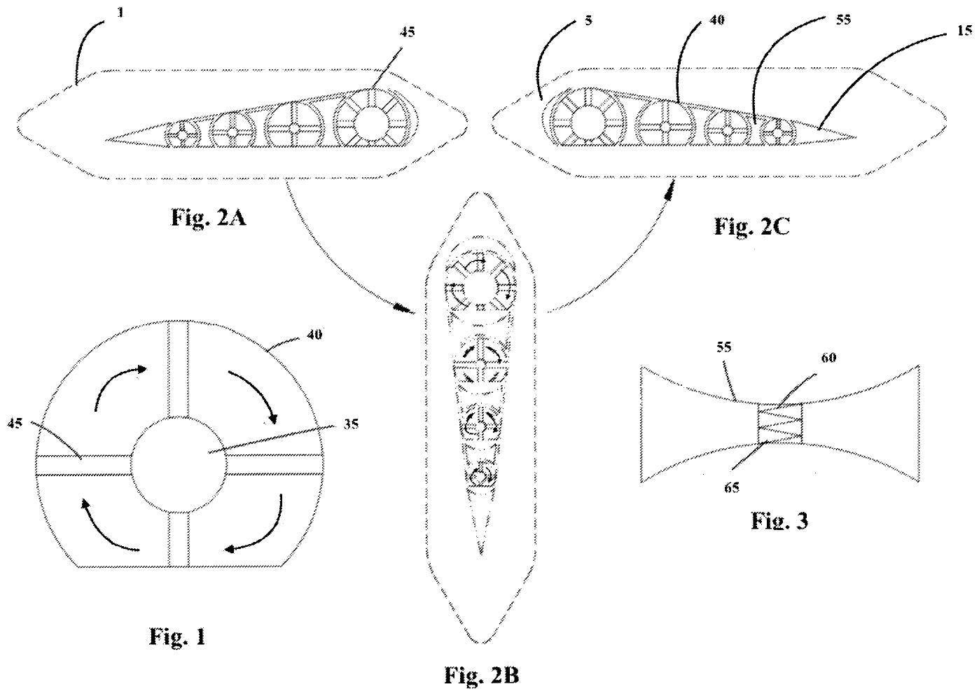

FIG. 1 is a sectional view of a 25% flat side tube.

FIG. 2 (A-C) is a sectional view symmetrical component foil with 25% flat side tubes rotating while the vessel is flipping.

FIG. 3 is a sectional view of a spacer with a flexible joint and spacer spring.

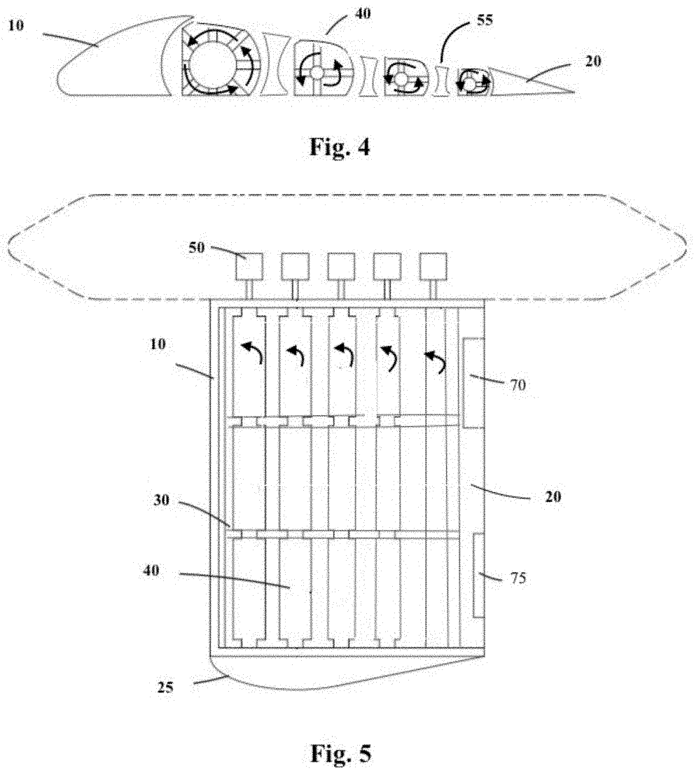

FIG. 4 is a sectional view of asymmetrical component foil with two 25% flat sided and two 25% differently top shaped tubes rotating.

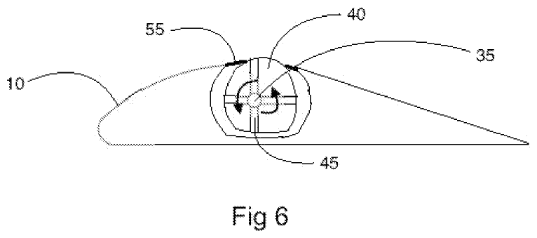

FIG. 5 is a sectional top view of FIG. 4 showing asymmetrical component foil with engines and rotating tubes.

### DETAILED DESCRIPTION OF THE INVENTION

This is a foil with a changeable lifting profile by means of tubes capable of rotation and locking into position. The tubes help form the foil structure in addition to shaping the top and bottom surface. The tube axles can independently rotate allowing optional lift and control of the vessel. An aircraft could have one foil tube rotate while the other tubes stay stationary changing the lift balance and resulting in turning the craft. Many other stationary vs rotating tube combinations are possible changing the functionality of foil to the vessel.

The foil wherein is bounded by a leading edge, a trailing edge, and a foil tip and ribs located between the leading edge and trailing edge. It is unique by the addition of optional combinations of rotating tubes. Within the foil perpendicular to and positioned between the ribs are one or more tubes connected by struts to axles. The axles begin inside the vessel then travel through and rest on a plurality of bearings positioned in the ribs starting from the inside the vessel and ending at the foil tip, wherein the tubes can be tapered and become narrower as they extend toward the foil tip. The tubes have one or more generally flat areas that are coplanar with and help define the bottom surface of the foil. A plurality of concentrically smaller tubes become relatively smaller towards the trailing edge, they help define the shape of the foil. A plurality of spacers are located between the tubes with optional foil surface covering, to help construct a smooth foil surface. Traditional foil control surfaces can be added including flaps and ailerons, etc . . .

The tubes are rotated and are locked into position in response to a control signal by means of one or more engines, hydraulic, pneumatic, gear driven or manual components or systems (hereinafter referred to as the engine), which can be located in the foil or alternatively in the vessel.

The foil surfaces can be covered with skin or surface covering composed of a wide range of materials to allow a smooth surface. Appropriate coverings are resistant to wear, resilient or reflexive such that they can stretch and recoil to accommodate the moving tubes, and strong enough to protect the moving components of the invention. Surface covering can be over the entire foil or can extend across the moveable components.

A cover tensioner mechanism can be added to temporarily shift the tubes to relax the covering. This allows easier movement of the tubes during rotation and less wear on the covering. When the tubes finish movement, the cover tensioner tightens the covering, thereby creating a smoother surface for creating lift and carrying the foil load.

An objective of this invention is to provide a device and method of use to allow optimization of fluid dynamic efficiencies comprising a foil or vessel design capable of orientational change. It is another objective of this invention to provide a foil structure capable of relatively high lift coefficient at one point in transit and modulation via configurational change to optimize for reduced drag.

The attached figures form part of the present specification and are included to further demonstrate certain aspects of the present claimed subject matter, and should not be used to limit or define it. The present subject matter may be better understood by reference to one or more of these drawings in combination with the description of embodiments presented herein.

FIG. 1, shows a detailed sectional view of a tube with one flat area occupying approximately 25% percent of the tube circumference. Tube struts support and connect each tube to an axle. One skilled in the art would appreciate that smaller or greater percentages of the circumference of the tube could be flattened and still remain within the scope of this disclosure.

FIG. 2, This embodiment is a sectional view of a foil with a symmetric leading edge, symmetric foil tip and a symmetric trailing edge .(A-C) depict an embodiment of the invention wherein the vessel flips or inverts; and the tubes rotate 180 degrees in order to change configuration of the foil, such that the flat portion of each tube is aligned coplanar with the bottom of the foil maintaining fluid dynamic lift of the vessel in the new orientation.
(A) The vessel is heading toward the right side of the sheet. The tubes are arranged such that a flat portion of each tube is at the bottom of the foil. As the vessel rotates, the tubes roll to allow the flat portion to remain at the bottom of the foil.
(B) Displays the vessel changing direction, while the tubes roll such that the flat portion moves.
(C) The vessel is moving toward the left side of the sheet.

Leading edge and trailing edge configuration is maintained in the new direction and the tubes have stopped rotating such that the flat areas are coplanar with the bottom of the foil.

FIG. 3 is a detailed view of a spacer component which is affixed to the foil's ribs. The spacers help fill the gaps between tubes to achieve a smooth foil surface. Spacer springs and flexible joints capable of tension and recoil are integrated into the spacers. The spacer shifts and recoils as the tubes rotate while the surface changes from flat to round.

FIG. 4 is a sectional view displaying a foil using tubes that have two flat surfaces and two modified top shapes each approximately 25% of the circumference. This configuration provides multiple optional conformations of top surface foil design, and greatly enhances the foil's fluid dynamic efficiencies for different applications. These tubes only rotate 90 degrees such that one of the flat portions can be aligned coplanar with the relatively flat bottom surface of the foil. Multiple flat surfaces enable the tubes to quickly change because they rotate 50% less than a single flat surface tube. The foil shape lift profile efficiency is enhanced and allows the foil to have more optional modified top shapes, in addition to fluid dynamic control. Asymmetric components are used in this foil design, including leading edge, ribs, trailing edge and foil tips; this greatly enhances fluid dynamic efficiency. This novel functionality would allow the tubes to rotate independently to achieve multiple modified foil shapes.

FIG. 5 shows a top sectional view of FIG. 4. Multiple asymmetric rib sections may be combined to extend and expand the foil to any dimension. This view shows the tubes typically become concentrically smaller to the trailing edge. Tubes and segments therein can be tapered or generally conical in configuration. In this way, they can accommodate foils that are wide at the vessel body and narrow as they extend the length of the foil to its tip. Functionally, this would be helpful for an aircraft to take off on a short runway and change airfoil configuration for faster speed at cruise altitude. This would be particularly helpful in use with drones and other types of unmanned aerial vehicles (UAV's).

Insofar as the description above and the accompanying drawings disclose any additional subject matter that is not within the scope of the single claim below, the inventions are not dedicated to the public and the right to file one or more applications to claim such additional inventions are reserved.

While various embodiments are described herein, it should be appreciated that the present invention encompasses many innovative concepts that may be embodied in a wide variety of contexts. Illustrative embodiments of the invention are described below. Not all features of an actual implementation for all embodiments are necessarily described in this specification. There are many possible combinations of tube arrangements in this invention.

In the development of any such actual embodiment/implementation, specific decisions may be made to achieve the design specific goals, which may vary from one implementation to another. It will be appreciated that such a development effort would be a routine undertaking for persons of ordinary skill in the art having the benefit of this disclosure.

I claim:

1. A foil comprising of a changeable lifting foil profile, wherein the foil is comprising of a foil leading edge, a foil trailing edge, and a foil tip, ribs located between the leading edge and trailing edge; perpendicular to and positioned between the ribs one or more tubes that can be segmented between the ribs and can become smaller as they extend toward the foils trailing edge: wherein tubes can be connected by struts to an axle wherein the axles start in vessel body travel through and rest on a plurality of bearings in the foil ribs ending at the foil tip, wherein the wherein axles can independently rotate in response to a control signal wherein the one or more tubes, axles are capable of rotation and connected to one or more engines, a mechanical apparatus or a hydraulic power control system; a plurality of spacer springs and elastic joints can be located between the tubes: connected and segmented between the ribs and further comprising of wherein the foil surface can be covered with material capable of stretch and recoil one or more covering tensioners; further including flaps and ailerons for added foil surface control.

2. The device of claim 1 wherein tubes consisting of one flat area wherein the leading edge, trailing edge, ribs and foil tip are symmetrical.

3. The device of claim 1 wherein the tubes consisting of two flat sided bottom and two different shaped top shapes wherein the leading edge, trailing edge, ribs and foil tip are asymmetrical.

4. The device of claim 1 wherein the tubes consisting of two flat sided bottom and two different shaped top shapes wherein the leading edge, trailing edge, ribs and foil tip are symmetrical.
